(19) United States
(12) Patent Application Publication
(10) Pub. No.: US 2013/0094083 A1
(43) Pub. Date: Apr. 18, 2013

(54) PRESSURE-SENSITIVE ADHESIVE LAYER FOR OPTICAL FILM, PRESSURE-SENSITIVE ADHESIVE OPTICAL FILM, AND IMAGE DISPLAY

(71) Applicants: Takaaki Ishii, Ibaraki-shi (JP); Kunihiro Inui, Ibaraki-shi (JP); Toshitsugu Hosokawa, Ibaraki-shi (JP); Masayuki Satake, Ibaraki-shi (JP)

(72) Inventors: Takaaki Ishii, Ibaraki-shi (JP); Kunihiro Inui, Ibaraki-shi (JP); Toshitsugu Hosokawa, Ibaraki-shi (JP); Masayuki Satake, Ibaraki-shi (JP)

(73) Assignee: NITTO DENKO CORPORATION, Ibaraki-shi, Osaka (JP)

(21) Appl. No.: 13/703,714

(22) PCT Filed: Jun. 17, 2011
(86) PCT No.: PCT/JP2011/063947

§ 371 Date: Dec. 12, 2012

(30) Foreign Application Priority Data
Jun. 28, 2010 (JP) 2010-146684
May 26, 2011 (JP) 2011-118364

(51) Int. Cl. C09J 133/12; G02B 5/30

(52) U.S. Cl. CPC C09J 133/12; G02B 5/30
USPC 359/483.01; 526/318.44; 428/355 AC; 428/354; 428/351

(57) ABSTRACT

The pressure-sensitive adhesive layer for an optical film having good heat and moisture durability is formed by a process of applying an aqueous dispersion-type pressure-sensitive adhesive containing an emulsion of a (meth)acryl-based polymer obtained by subjecting a monomer mixture containing at least one of an alkyl (meth)acrylate (a1) with an alkyl group of 1 to 3 carbon atoms and an alkoxysilyl group-containing monomer (a2), and an alkyl (meth)acrylate (b) with an alkyl group of 4 to 14 carbon atoms to emulsion polymerization in water in the presence of a radical polymerization initiator and a reactive surfactant having a radically-polymerizable functional group; and then drying the emulsion, wherein a content of the reactive surfactant is 0.3 to 3 parts by weight based on 100 parts by weight of the monomer mixture, and has a saturated water absorption of 1.2 to 3.2% by weight at 50° C. and 90% R.H.

### TECHNICAL FIELD

The present invention relates to a pressure-sensitive adhesive layer for an optical film made from an aqueous dispersion-type pressure-sensitive adhesive, and the present invention also relates to a pressure-sensitive adhesive optical film including an optical film and the pressure-sensitive adhesive layer laminated thereon. The present invention also relates to an image display such as a liquid crystal display, an organic electroluminescence (EL) display, a cathode-ray tube (CRT), or a plasma display panel (PDP) produced using the pressure-sensitive adhesive optical film and to a part used together with an image display, such as a front face plate, produced using the pressure-sensitive adhesive-type optical film. Examples of the optical film that may be used include a polarizing plate, a retardation plate, an optical compensation film, a brightness enhancement film, a surface treatment film such as an anti-reflection film, and a laminate of any combination thereof.

### Description of the Related Art

Liquid crystal displays, organic EL displays, etc. have an image-forming mechanism including polarizing elements as essential components. For example, therefore, in a liquid crystal display, polarizing elements are essentially placed on both sides of a liquid crystal cell, and generally, polarizing plates which include a polarizer and a transparent protective film bonded on one side or both sides of the polarizer are attached as the polarizing elements. Besides polarizing plates, various optical elements have been used in display panels such as liquid crystal panels and organic EL panels for improving display quality. Front face plates are also used to protect image displays such as liquid crystal displays, organic EL displays, CRTs, and PDPs or to provide a high-grade appearance or a differentiated design. Examples of parts used in image displays such as liquid crystal displays and organic EL displays or parts used together with image displays, such as front face plates, include retardation plates for preventing discoloration, viewing angle-widening films for improving the viewing angle of liquid crystal displays, brightness enhancement films for increasing the contrast of displays, and surface treatment films such as hard-coat films for use in imparting scratch resistance to surfaces, antiglare treatment films for preventing glare on image displays, and anti-reflection films such as anti-reflective films and low-reflective films. These films are generically called optical films.

When such optical films are bonded to a display panel such as a liquid crystal cell or an organic EL panel or bonded to a front face plate, a pressure-sensitive adhesive is generally used. In the process of bonding an optical film to a display panel such as a liquid crystal cell or an organic EL panel or to a front face plate or bonding optical films together generally reduce optical loss. Therefore, a pressure-sensitive adhesive is used to bond the materials together. In such a case, a pressure-sensitive adhesive optical film including an optical film and a pressure-sensitive adhesive layer previously formed on one side of the optical film is generally used, because it has some advantages such as no need for a drying process to fix the optical film.

Triacetylcellulose films have been preferably used as transparent protective films for the polarizing plate. Unfortunately, triacetylcellulose does not have sufficient resistance to moisture or heat, and polarizing plates including a triacetylcellulose film as a transparent protective film have the disadvantage that their performance such as polarization degree or hue will be reduced when they are used at high temperature or high humidity. In addition, light obliquely incident on triacetylcellulose films can cause certain retardation. The retardation can significantly affect the viewing angle characteristics of liquid crystal displays, as they have increased in size in recent years. To solve the problems described above, it is proposed that cyclic olefin resin should be used in place of triacetylcellulose as a material for transparent protective films. Cyclic olefin resin has low moisture permeability and almost no retardation in oblique directions.

Unfortunately, because cyclic olefin resin has low moisture permeability, a pressure-sensitive adhesive optical film serving as a polarizing plate and having a transparent protective film made of cyclic olefin resin has a problem in which it can cause foaming in an endurance test where it is allowed to stand in a high-temperature environment while bonded to a glass substrate. The foaming problem does not occur when triacetylcellulose is used as a material for transparent protective films.

For example, a method proposed to control the problem of foaming in the pressure-sensitive adhesive optical film includes using a pressure-sensitive adhesive layer having a saturated water absorption of 0.60% by weight or less and an adhesive strength of 600 g/20 mm or less at a peel angle of 90° to the adherend (Patent Document 1). Patent Document 1 discloses that when the saturated water absorption is controlled to a low level, foaming can be suppressed. Unfortunately, when cyclic olefin resin with low moisture permeability is used as a material for a transparent protective film of a polarizing plate, foaming cannot be suppressed simply by reducing the saturated water absorption.

On the other hand, in recent years, solvent-free pressure-sensitive adhesives, which are produced with no organic solvent, have been developed aggressively in view of a reduction in global environmental loading or an improvement in process stability. For example, a known solvent-free pressure-sensitive adhesive is an aqueous dispersion-type pressure-sensitive adhesive containing a pressure-sensitive adhesive polymer component dispersed in water used as a dispersion medium. For example, it is proposed that such an aqueous dispersion-type pressure-sensitive adhesive should be a pressure-sensitive adhesive composition containing a copolymer emulsion, in which the copolymer includes 10 to 50% by weight of (A) 2-ethylhexyl methacrylate as a copolymerized component based on the total amount of the copolymer, and the copolymer has a glass transition temperature of −25° C. or less (Patent Document 2).

Unfortunately, the pressure-sensitive adhesive layer made from the aqueous dispersion-type pressure-sensitive adhesive disclosed in Patent Document 2 has low tackiness to a hydrophilic adherend such as glass and therefore has the problem of low tackiness to glass substrates for use in liquid crystal displays, etc., although it has improved tackiness to a hydrophobic adherend such as polyolefin. In the field of optical films for use in liquid crystal displays, etc., high resistance to heat or moisture is required so that adhesion will not be reduced even in harsh, hot or humid environments. Therefore, it has been difficult to use the aqueous dispersion-type pressure-sensitive adhesive of Patent Document 2 for optical films. In addition, the pressure-sensitive adhesive layer made from the aqueous dispersion-type pressure-sensitive adhesive composition contains a water-soluble component such as a surfactant. Therefore, even if the aqueous dispersion-type pressure-sensitive adhesive composition of Patent Document 1 is used to form a pressure-sensitive adhesive layer, the product cannot have satisfactory moisture durability.

In the field of optical films, some proposals also have been made to improve the durability. For example, it is proposed that an emulsion of an acryl-based polymer produced with an alkyl (meth)acrylate and a silane monomer should be used to form an optical film-forming, aqueous dispersion-type pressure-sensitive adhesive capable of improving adhesion to the glass substrate of a liquid crystal panel (Patent Document 3).

Unfortunately, when used to bond a cyclic olefin-based optical film to a glass substrate, the pressure-sensitive adhesive layer made from the aqueous dispersion-type pressure-sensitive adhesive disclosed in Patent Document 3 causes foaming in a high-temperature environment due to the low moisture permeability of the cyclic olefin resin and therefore does not have satisfactory heat durability, although it has satisfactory heat durability when used to bond a triacetylcellulose-based optical film.

### PRIOR ART DOCUMENTS

### Patent Documents

Patent Document 1: JP-A-09-281336

Patent Document 2: JP-A-2001-254063

Patent Document 3: JP-A-2007-186661

### SUMMARY OF THE INVENTION

### Problems to be Solved by the Invention

An object of the present invention is to provide an pressure-sensitive adhesive layer for an optical film that is suitable for use in optical films, is made from an aqueous dispersion-type pressure-sensitive adhesive, has satisfactory heat durability in a high-temperature environment and also has satisfactory moisture durability in a high-humidity environment even when the pressure-sensitive adhesive layer is placed on an optical film made of a low-moisture-permeability material.

Another object of the present invention is to provide a pressure-sensitive adhesive optical film including an optical film and the pressure-sensitive adhesive layer for an optical film placed on at least one side of the optical film. A further object of the present invention is to provide an image display including the pressure-sensitive adhesive optical film.

As a result of earnest studies to solve the above problems, the inventors have accomplished the present invention based on the finding that the pressure-sensitive adhesive layer for an optical film etc., described below can solve the problems.

The present invention relates to a pressure-sensitive adhesive layer for an optical film, which is formed by a process including:
applying an aqueous dispersion-type pressure-sensitive adhesive containing an emulsion of a (meth)acryl-based polymer obtained by subjecting a monomer mixture containing
at least one of an alkyl (meth)acrylate (a1) with an alkyl group of 1 to 3 carbon atoms and an alkoxysilyl group-containing monomer (a2), and
an alkyl (meth)acrylate (b) with an alkyl group of 4 to 14 carbon atoms
to emulsion polymerization in water in the presence of a radical polymerization initiator and a reactive surfactant having a radically-polymerizable functional group; and then drying the emulsion,
wherein a content of the reactive surfactant is 0.3 to 3 parts by weight based on 100 parts by weight of the monomer mixture, and
the pressure-sensitive adhesive layer has a saturated water absorption of 1.2 to 3.2% by weight at 50° C. and 90% R.H.

In the pressure-sensitive adhesive layer for an optical film, wherein the content of the reactive surfactant is preferably 0.3 to less than 2 parts by weight based on 100 parts by weight of the monomer mixture.

In the pressure-sensitive adhesive layer for an optical film, the monomer mixture preferably contains 0.1 to 40% by weight of the alkyl (meth)acrylate (a1) with an alkyl group of 1 to 3 carbon atoms and 50 to 99.9% by weight of the alkyl (meth)acrylate (b) with an alkyl group of 4 to 14 carbon atoms based on the total amount of the monomer mixture.

In the pressure-sensitive adhesive layer for an optical film, the monomer mixture preferably contains 0.001 to 1% by weight of the alkoxysilyl group-containing monomer (a2) and 89 to 99.999% by weight of the alkyl (meth)acrylate (b) with an alkyl group of 4 to 14 carbon atoms based on the total amount of the monomer mixture.

In the pressure-sensitive adhesive layer for an optical film, the monomer mixture preferably contains 0.1 to 40% by weight of the alkyl (meth)acrylate (a1) with an alkyl group of 1 to 3 carbon atoms, 0.001 to 1% by weight of the alkoxysilyl group-containing monomer (a2), and 89 to 99.999% by weight of the alkyl (meth)acrylate (b) with an alkyl group of 4 to 14 carbon atoms based on the total amount of the monomer mixture.

In the pressure-sensitive adhesive layer for an optical film, the monomer mixture preferably contains 0.1 to 10% by weight of a carboxyl group-containing monomer (c) based on the total amount of the monomer mixture.

The pressure-sensitive adhesive layer for an optical film preferably has an elongation percentage (L60) of 200% or less in an environment at 60° C. and 7% R.H. and a ratio {(L60−90)/(L60)} of at least 1.5, wherein {(L60−90)/(L60)} is the ratio of an elongation percentage (L60−90) in an environment at 60° C. and 90% R.H. to the elongation percentage (L60) in an environment at 60° C. and 7% R.H.

Provided that the elongation percentage is determined from the following equation: elongation percentage (%)={(L1−L0)/L0}×100 by a process including forming the pressure-sensitive adhesive layer into a cylindrical test piece with a cross section of 4.6=² and a length of 30 mm, allowing the test piece to stand in an environment at 60° C. and 7% R.H. or at 60° C. and 90% R.H. for 1 hour, then measuring the length L0 (mm) of the test piece, then suspending the test piece in an environment at 60° C. and 7% R.H. or at 60° C. and 90% R.H. for 2 hours, while fixing one end of the test piece and attaching a 12 g weight to the other end of the test piece, and then measuring the length L1 (mm) of the test piece

The present invention also relates to a pressure-sensitive adhesive optical film including an optical film and the above pressure-sensitive adhesive layer for an optical film placed on at least one side of the optical film.

The pressure-sensitive adhesive optical film is preferably used, even when the optical film, on which the pressure-sensitive adhesive layer is placed, has a moisture permeability of 1,000 g/m² per 24 hours at 80° C. and 90% R.H. or less.

The optical film is mentioned as a polarizing plate including a polarizer and a transparent protective film provided on at least one side of the polarizer.

The present invention also relates to an image display including at least one piece of the above pressure-sensitive adhesive optical film.

### EFFECT OF THE INVENTION

The pressure-sensitive adhesive layer for an optical film of the present invention is made from an aqueous dispersion-type pressure-sensitive adhesive containing, as a base polymer, a (meth)acryl-based polymer obtained by subjecting a monomer mixture of the specified composition to emulsion polymerization using the specified amount of a reactive surfactant having a radically-polymerizable functional group. In addition, the saturated water absorption of the pressure-sensitive adhesive layer of the present invention is controlled within the specified range (1.2 to 3.2% by weight). Therefore, the pressure-sensitive adhesive layer for an optical film of the present invention has satisfactory durability against heat and moisture because the composition of the aqueous dispersion-type pressure-sensitive adhesive used to form the pressure-sensitive adhesive layer and the saturated water absorption of the pressure-sensitive adhesive layer being formed are controlled as described above.

### MODE FOR CARRYING OUT THE INVENTION

The pressure-sensitive adhesive layer for an optical film of the present invention is formed by a process including applying an aqueous dispersion-type pressure-sensitive adhesive and then drying the adhesive. The pressure-sensitive adhesive layer has a controlled saturated water absorption of 1.2 to 3.2% by weight.

If the saturated water absorption of the pressure-sensitive adhesive layer is more than 3.2% by weight, a relatively large amount of water can be accumulated in the pressure-sensitive adhesive layer. Consequently, in a high-temperature environment, a relatively large amount of water can be expanded and vaporized from the pressure-sensitive adhesive layer, so that foaming will be more likely to occur and therefore satisfactory heat durability cannot be achieved. Additionally, in a high-humidity environment, the water can plasticize the pressure-sensitive adhesive layer to cause a significant reduction in cohesive strength, so that peeling will be more likely to occur therefore satisfactory moisture durability cannot be achieved. On the other hand, if the saturated water absorption of the pressure-sensitive adhesive layer is less than 1.2% by weight, the amount of water that can be accumulated in the pressure-sensitive adhesive layer will be relatively small. Consequently, the pressure-sensitive adhesive layer will be relatively hard and have reduced interface adhesion, so that it will be more likely to peel in a high-humidity environment and therefore cannot have satisfactory moisture durability. The saturated water absorption of the pressure-sensitive adhesive layer is preferably from 1.4 to 2.5% by weight and more preferably from 1.4 to 2% by weight.

The pressure-sensitive adhesive layer is formed using an aqueous dispersion-type pressure-sensitive adhesive (emulsion-type pressure-sensitive adhesive) containing an emulsion of a (meth)acryl-based polymer obtained by subjecting a monomer mixture of a specific composition to emulsion polymerization in water in the presence of a radical polymerization initiator and a specific amount of a reactive surfactant having a radically-polymerizable functional group.

The monomer mixture contains: at least one of an alkyl (meth)acrylate (a1) with an alkyl group of 1 to 3 carbon atoms and an alkoxysilyl group-containing monomer; and (b) an alkyl (meth)acrylate with an alkyl group of 4 to 14 carbon atoms (a2). The alkyl (meth)acrylate (b) with an alkyl group of 4 to 14 carbon atoms is a main component for imparting adherability to the (meth)acryl-based polymer, and the alkyl (meth)acrylate (a1) with an alkyl group of 1 to 3 carbon atoms and the alkoxysilyl group-containing monomer (a2) are components for imparting cohesive strength to the (meth)acryl-based polymer. The term “alkyl (meth)acrylate” refers to alkyl acrylate and/or alkyl methacrylate, and “(meth)” is used in the same meaning in the description.

Examples of the alkyl (meth)acrylate (a1) with an alkyl group of 1 to 3 carbon atoms include methyl (meth)acrylate, ethyl (meth)acrylate, n-propyl (meth)acrylate, and isopropyl (meth)acrylate. Among these, methyl methacrylate is preferred.

The alkoxysilyl group-containing monomer (a2) maybe a silane coupling agent-type unsaturated monomer having an alkoxysilyl group and a group having at least one unsaturated double bond, such as a (meth)acryloyl group or a vinyl group.

Examples of the alkoxysilyl group-containing monomer (a2) include an alkoxysilyl group-containing (meth)acrylate monomer and an alkoxysilyl group-containing vinyl monomer. Examples of the alkoxysilyl group-containing (meth)acrylate monomer include (meth)acryloyloxyalkyl-trialkoxysilanes such as (meth)acryloyloxymethyl-trimethoxysilane, (meth)acryloyloxymethyl-triethoxysilane, 2-(meth)acryloyloxyethyl-trimethoxysilane, 2-(meth)acryloyloxyethyl-triethoxysilane, 3-(meth)acryloyloxypropyl-trimethoxysilane, 3-(meth)acryloyloxypropyl-triethoxysilane, 3-(meth)acryloyloxypropyl-tripropoxysilane, 3-(meth)acryloyloxypropyl-triisopropoxysilane, and 3-(meth)acryloyloxypropyl-tributoxysilane; (meth)acryloyloxyalkyl-alkyldialkoxysilanes such as (meth)acryloyloxymethyl-methyldimethoxysilane, (meth)acryloyloxymethyl-methyldiethoxysilane, 2-(meth)acryloyloxyethyl-methyldimethoxysilane, 2-(meth)acryloyloxyethyl-methyldiethoxysilane, 3-(meth)acryloyloxypropyl-methyldimethoxysilane, 3-(meth)acryloyloxypropyl-methyldiethoxysilane, 3-(meth)acryloyloxypropyl-methyldipropoxysilane, 3-(meth)acryloyloxypropyl-methyldiisopropoxysilane, 3-(meth)acryloyloxypropyl-methyldibutoxysilane, 3-(meth)acryloyloxypropyl-ethyldimethoxysilane, 3-(meth)acryloyloxypropyl-ethyldiethoxysilane, 3-(meth)acryloyloxypropyl-ethyldipropoxysilane, 3-(meth)acryloyloxypropyl-ethyldiisopropoxysilane, 3-(meth)acryloyloxypropyl-ethyldibutoxysilane, 3-(meth)acryloyloxypropyl-propyldimethoxysilane, and 3-(meth)acryloyloxypropyl-propyldiethoxysilane; and (meth)acryloyloxyalkyl-dialkyl(mono)alkoxysilanes corresponding to these monomers. For example, alkoxysilyl group-containing vinyl monomers include vinyltrialkoxysilanes such as vinyltrimethoxysilane, vinyltriethoxysilane, vinyltripropoxysilane, vinyltriisopropoxysilane, and vinyltributoxysilane, and vinylalkyldialkoxysilanes and vinyldialkylalkoxysilanes corresponding thereto; vinylalkyltrialkoxysilanes such as vinylmethyltrimethoxysilane, vinylmethyltriethoxysilane, β-vinylethyltrimethoxysilane, β-vinylethyltriethoxysilane, γ-vinylpropyltrimethoxysilane, γ-vinylpropyltriethoxysilane, γ-vinylpropyltripropoxysilane, γ-vinylpropyltriisopropoxysilane, and γ-vinylpropyltributoxysilane, and (vinylalkyl)alkyldialkoxysilanes and (vinylalkyl)dialkyl(mono)alkoxysilanes corresponding thereto.

The alkyl (meth)acrylate (b) has an alkyl group of 4 to 14 carbon atoms, in which the alkyl group maybe a straight chain or a branched chain. Examples of the alkyl group of 4 to 14 carbon atoms include a n-butyl group, an isobutyl group, a sec-butyl group, a tert-butyl group, a pentyl group, a neopentyl group, an isoamyl group, a hexyl group, a heptyl group, a 2-ethylhexyl group, an isooctyl group, a nonyl group, an isononyl group, a decyl group, an isodecyl group, a dodecyl group, a tridecyl group, and a tetradecyl group. Among these, alkyl (meth)acrylates with an alkyl group of 4 to 9 carbon atoms are preferred, such as n-butyl (meth)acrylate, 2-ethylhexyl (meth)acrylate, and n-octyl (meth)acrylate.

Examples of the monomer mixture may include those listed below.

Monomer mixture (1): a mixture containing a C₁-C₃ alkyl (meth)acrylate (a1) and a C₄-C₁₄ alkyl (meth)acrylate (b).

Monomer mixture (2): a mixture containing an alkoxysilyl group-containing monomer (a2) and a C₄-C₁₄ alkyl (meth)acrylate (b).

Monomer mixture (3): a mixture containing a C₁-C₃ alkyl (meth)acrylate (a1), an alkoxysilyl group-containing monomer (a2), and a C₄-C₁₄ alkyl (meth)acrylate (b).

The monomer mixture (1) preferably contains 0.1 to 40% by weight of the C₁-C₃ alkyl (meth)acrylate (a1) and 50 to 99.9% by weight of the C₄-C₁₄ alkyl (meth)acrylate (b), based on the total amount of the monomer mixture.

When the content of the alkyl (meth)acrylate (a1) is 0.1% by weight or more, an appropriate level of cohesive strength can be imparted to the pressure-sensitive adhesive layer, which is preferred in order to suppress foaming of the pressure-sensitive adhesive layer in a high-temperature environment and to achieve satisfactory heat durability. When the content is 40% by weight or less, the pressure-sensitive adhesive layer can be prevented from being too hard, which is preferred in order to suppress peeling in a high-temperature or high-humidity environment and to achieve satisfactory heat or moisture durability. The content of the alkyl (meth)acrylate (a1) is more preferably from 1 to 30% by weight, and even more preferably from 5 to 20% by weight.

On the other hand, the content of the alkyl (meth)acrylate (b) in the monomer mixture (1) is preferably from 50 to 99.9% by weight, more preferably from 60 to 99% by weight, even more preferably from 70 to 95% by weight, and still more preferably from 75 to 90% by weight.

The monomer mixture (2) preferably contains 0.001 to 1% by weight of the alkoxysilyl group-containing monomer (a2) and 89 to 99.999% by weight of the C₄-C₁₄ alkyl (meth)acrylate (b), based on the total amount of the monomer mixture.

When the content of the alkoxysilyl group-containing monomer (a2) is 0.001% by weight or more, an appropriate level of cohesive strength can be imparted to the pressure-sensitive adhesive layer, which is preferred in order to suppress foaming of the pressure-sensitive adhesive layer in a high-temperature environment and to achieve satisfactory heat durability. The content of the alkoxysilyl group-containing monomer (a2) is also preferred in order to provide a crosslinked structure and obtain the effect of adhesion to glass. When the content is 1% by weight or less, the pressure-sensitive adhesive layer can be prevented from having a too high degree of crosslinkage and being too hard, which is preferred in order to suppress peeling in a high-temperature or high-humidity environment and achieve satisfactory heat or moisture durability. The content of the alkoxysilyl group-containing monomer (a2) is more preferably from 0.01 to 0.5% by weight, and even more preferably from 0.03 to 0.1% by weight.

On the other hand, the content of the alkyl (meth)acrylate (b) in the monomer mixture (2) is preferably from 89 to 99.999% by weight, more preferably from 90 to 99.9% by weight, and even more preferably from 95 to 99% by weight.

The monomer mixture (3) preferably contains 0.1 to 40% by weight of the alkyl (meth)acrylate (a1) and 0.001 to 1% by weight of the alkoxysilyl group-containing monomer (a2), based on the total amount of the monomer mixture, and these contents can be controlled within the above preferred ranges, respectively. Specifically, the content of the alkyl (meth)acrylate (a1) is more preferably from 1 to 30% by weight, and even more preferably from 5 to 20% by weight. The content of the alkoxysilyl group-containing monomer (a2) is more preferably from 0.01 to 0.5% by weight, and even more preferably from 0.03 to 0.1% by weight. The content of the alkyl (meth)acrylate (b) can be adjusted depending on the contents of the alkyl (meth)acrylate (a1) and the alkoxysilyl group-containing monomer (a2).

In addition to the above described monomer, at least one copolymerizable monomer having an unsaturated double bond-containing polymerizable group such as a (meth)acryloyl group or a vinyl group may be introduced into the monomer mixtures forming the (meth)acryl-based polymer in order to stabilize water dispersibility, to improve adhesion to a base material such as an optical film for the pressure-sensitive adhesive layer, and to improve initial tackiness to the adherend.

To improve the tackiness of the pressure-sensitive adhesive and provide stability for the emulsion, a carboxyl group-containing monomer is preferably used as the copolymerizable monomer. The carboxyl group-containing monomer may be monomer having a carboxyl group and a radically-polymerizable unsaturated double bond-containing group such as a (meth)acryloyl group or a vinyl group, examples of which include (meth)acrylic acid, itaconic acid, maleic acid, fumaric acid, crotonic acid, carboxyethyl acrylate, and carboxypentyl acrylate.

The content of the carboxyl group-containing monomer is preferably from 0.1 to 10% by weight, more preferably from 0.5 to 7% by weight, and even more preferably from 1 to 5% by weight, based on the total amount of the monomer mixture. When the content of the carboxyl group-containing monomer is 0.1% by weight or more, mechanical stability can be imparted to the emulsion, so that the formation of aggregates can be prevented when a shear is applied to the emulsion. Setting the content at 10% by weight or less is preferred in order to keep the solubility of the pressure-sensitive adhesive layer at a low level and achieve satisfactory moisture durability.

Examples of copolymerizable monomers also include acid anhydride group-containing monomers such as maleic anhydride and itaconic anhydride; an alicyclic hydrocarbon ester of (meth)acrylic acid such as cyclohexyl (meth)acrylate, bornyl (meth)acrylate, and isobornyl (meth)acrylate; aryl (meth)acrylate such as phenyl (meth)acrylate; vinyl esters such as vinyl acetate and vinyl propionate; styrene monomers such as styrene; epoxy group-containing monomers such as glycidyl (meth)acrylate and methylglycidyl (meth)acrylate; hydroxyl group-containing monomers such as 2-hydroxyethyl (meth)acrylate, 2-hydroxypropyl (meth)acrylate and 4-hydroxybutyl (meth)acrylate; nitrogen atom-containing monomers such as (meth)acrylamide, N,N-dimethyl(meth)acrylamide, N,N-diethyl(meth)acrylamide, N-isopropyl(meth)acrylamide, N-butyl(meth)acrylamide, N-methylol(meth)acrylamide, N-methylolpropane(meth)acrylamide, (meth)acryloylmorpholine, aminoethyl (meth)acrylate, N,N-dimethylaminoethyl (meth)acrylate, and tert-butylaminoethyl (meth)acrylate; alkoxy group-containing monomers such as methoxyethyl (meth)acrylate and ethoxyethyl (meth)acrylate; cyano group-containing monomers such as acrylonitrile and methacrylonitrile; functional monomers such as 2-methacryloyloxyethyl isocyanate; olefin monomers such as ethylene, propylene, isoprene, butadiene, and isobutylene; vinyl ether monomers such as vinyl ether; halogen atom-containing monomers such as vinyl chloride; and other monomers including vinyl group-containing heterocyclic compounds such as N-vinylpyrrolidone, N-(1-methylvinyl)pyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, and N-vinylmorpholine, and N-vinylcarboxylic acid amides.

Examples of the copolymerizable monomer also include maleimide monomers such as N-cyclohexylmaleimide, N-isopropylmaleimide, N-laurylmaleimide, and N-phenylmaleimide; itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide; succinimide monomers such as N-(meth)acryloyloxymethylenesuccinimide, N-(meth)acryloyl-6-oxyhexamethylenesuccinimide, and N-(meth)acryloyl-8-oxyoctamethylenesuccinimide; and sulfonic acid group-containing monomers such as styrenesulfonic acid, allylsulfonic acid, 2-(meth)acrylamido-2-methylpropanesulfonic acid, (meth)acrylamidopropanesulfonic acid, sulfopropyl (meth)acrylate, and (meth)acryloyloxynaphthalenesulfonic acid.

The copolymerizable monomer may be a phosphate group-containing monomer. For example, the phosphate group-containing monomer may be a phosphate group-containing monomer represented by formula (1) below or a salt thereof.

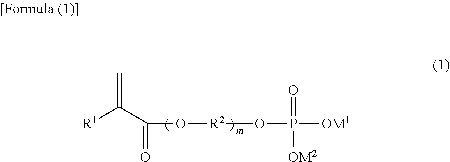

In formula (1), R¹ represents a hydrogen atom or a methyl group, R² represents an alkylene group of 1 to 4 carbon atoms, m represents an integer of 2 or more, and M¹ and M² each independently represent a hydrogen atom or a cation.

In formula (1), m is 2 or more, preferably 4 or more, generally 40 or less, and m represents the degree of polymerization of the oxyalkylene groups. The polyoxyalkylene group may be a polyoxyethylene group or a polyoxypropylene group, and these polyoxyalkylene groups may include random, block, or graft units. The cation of the salt of the phosphate group is typically, but not limited to, an inorganic cation such as an alkali metal such as sodium or potassium or an alkaline-earth metal such as calcium or magnesium, or an organic cation such as a quaternary amine.

Examples of the copolymerizable monomer also include glycol acrylate monomers such as polyethylene glycol (meth)acrylate, polypropylene glycol (meth)acrylate, methoxyethylene glycol (meth)acrylate, and methoxypolypropylene glycol (meth)acrylate; and other monomers such as acrylic ester monomers containing a heterocyclic ring or a halogen atom, such as tetrahydrofurfuryl (meth)acrylate and fluoro(meth)acrylate.

A polyfunctional monomer may also be used as the copolymerizable monomer for a purpose such as control of the gel fraction of the aqueous dispersion-type pressure-sensitive adhesive. The polyfunctional monomer may be a compound having two or more unsaturated double bonds such as those in (meth)acryloyl groups or vinyl groups. Examples that may also be used include (meth)acrylate esters of polyhydric alcohols, such as (mono or poly)alkylene glycol di(meth)acrylates including (mono or poly) ethylene glycol di(meth)acrylates such as ethylene glycol di(meth)acrylate, diethylene glycol di(meth)acrylate, triethylene glycol di(meth)acrylate, trimethylolpropane tri(meth)acrylate, and tetraethylene glycol di(meth)acrylate, (mono or poly) propylene glycol di(meth)acrylate such as propylene glycol di(meth)acrylate, neopentyl glycol di(meth)acrylate, 1,6-hexanediol di(meth)acrylate, pentaerythritol di(meth)acrylate, trimethylolpropane tri(meth)acrylate, pentaerythritol tri(meth)acrylate, and dipentaerythritol hexa(meth)acrylate; polyfunctional vinyl compounds such as divinylbenzene; and compounds having two or more reactive unsaturated double bonds which have different reactivity respectively, such as allyl (meth)acrylate and vinyl (meth)acrylate. The polyfunctional monomer may also be a compound having a polyester, epoxy or urethane skeleton to which two or more unsaturated double bonds are added in the form of functional groups such as (meth)acryloyl groups or vinyl groups in the same manner as the monomer mixture, such as polyester (meth)acrylate, epoxy (meth)acrylate, or urethane (meth)acrylate.

The content of the copolymerizable monomer (s) (exclusive of the carboxyl group-containing monomer) is preferably 10% by weight or less, and more preferably 5% by weight or less, based on the total amount of the monomer mixture.

The emulsion polymerization of the monomer mixture may be performed by a conventional method including emulsifying the monomer mixture in water. This method prepares an emulsion containing a (meth)acryl-based polymer as a base polymer. For example, the monomer mixture is subjected to the emulsion polymerization in the presence of a radical polymerization initiator and a specific amount of a reactive surfactant having a radically-polymerizable functional group, to which chain transfer agent or the like is optionally added as appropriate. More specifically, for example, a known emulsion polymerization method may be employed, such as a batch mixing method (batch polymerization method), a monomer dropping method, or a monomer emulsion dropping method. In the monomer dropping method, continuous dropping or divided dropping is appropriately selected. These methods may be appropriately combined. While reaction conditions and so on may be appropriately selected, for example, the polymerization temperature is preferably from about 40 to about 95° C., and the polymerization time is preferably from about 30 minutes to about 24 hours.

The reactive surfactant, which has a radically-polymerizable functional group such as a group having an ethylenic unsaturated double bond, can make small the saturated water absorption of the pressure-sensitive adhesive layer, as compared with a non-reactive surfactant. The reactive surfactant is also preferred in order to adjust the saturated water absorption of the pressure-sensitive adhesive layer to the above described value.

The reactive surfactant may be a radical-polymerizable surfactant prepared by introducing a radical-polymerizable functional group (radically reactive group) such as a propenyl group or an allyl ether group into an anionic surfactant or a nonionic surfactant. These surfactants may be appropriately used alone or in any combination. Among these surfactants, the radical-polymerizable surfactant having a radical-polymerizable functional group is preferably used in view of the stability of the aqueous dispersion or the durability of the pressure-sensitive adhesive layer.

Examples of the anionic surfactant include higher fatty acid salts such as sodium oleate; alkylarylsulfonate salts such as sodium dodecylbenzenesulfonate; alkylsulfate ester salts such as sodium laurylsulfate and ammonium laurylsulfate; polyoxyethylene alkyl ether sulfate ester salts such as sodium polyoxyethylene lauryl ether sulfate; polyoxyethylene alkyl aryl ether sulfate ester salts such as sodium polyoxyethylene nonyl phenyl ether sulfate; alkyl sulfosuccinic acid ester salts such as sodiummonooctyl sulfosuccinate, sodium dioctyl sulfosuccinate, and sodium polyoxyethylene lauryl sulfosuccinate, and derivatives thereof; and polyoxyethylene distyrenated phenyl ether sulfate ester salts. Examples of the nonionic surfactant include polyoxyethylene alkyl ethers such as polyoxyethylene lauryl ether and polyoxyethylene stearyl ether; polyoxyethylene alkyl phenyl ethers such as polyoxyethylene octyl phenyl ether and polyoxyethylene nonyl phenyl ether; sorbitan higher fatty acid esters such as sorbitan monolaurate, sorbitan monostearate, and sorbitan trioleate; polyoxyethylene sorbitan higher fatty acid esters such as polyoxyethylene sorbitan monolaurate; polyoxyethylene higher fatty acid esters such as polyoxyethylene monolaurate and polyoxyethylene monostearate; glycerin higher fatty acid esters such as oleic acid monoglyceride and stearic acid monoglyceride; and polyoxyethylene-polyoxypropylene block copolymers, and polyoxyethylene distyrenated phenyl ether.

Examples of anionic reactive surfactants include alkyl ether surfactants (examples of commercially available products include AQUALONKH-05, KH-10, and KH-20 manufactured by Dai-ichi Kogyo Seiyaku Co., Ltd., ADEKA REASOAP SR-10N and SR-20N manufactured by ADEKA CORPORATION, LATEMUL PD-104 manufactured by Kao Corporation, and others); sulfosuccinic acid ester surfactants (examples of commercially available products include LATEMUL S-120, S-120A, S-180P, and S-180A manufactured by Kao Corporation and ELEMINOL JS-2 manufactured by Sanyo Chemical Industries, Ltd., and others); alkyl phenyl ether surfactants or alkyl phenyl ester surfactants (examples of commercially available products include AQUALON H-2855A, H-3855B, H-3855C, H-3856, HS-05, HS-10, HS-20, HS-30, BC-05, BC-10, and BC-20 manufactured by Dai-ichi Kogyo Seiyaku Co., Ltd., and ADEKA REASOAP

SDX-222, SDX-223, SDX-232, SDX-233, SDX-259, SE-10N, and SE-20N manufactured by ADEKA CORPORATION); (meth)acrylate sulfate ester surfactants (examples of commercially available products include ANTOX MS-60 and MS-2N manufactured by Nippon Nyukazai Co., Ltd., ELEMINOL RS-30 manufactured by Sanyo Chemical Industries Co., Ltd., and others); and phosphoric acid ester surfactants (examples of commercially available products include H-3330PL manufactured by Dai-ichi Kogyo Seiyaku Co., Ltd. ADEKA REASOAP PP-70 manufactured by ADEKA CORPORATION, and others). Examples of nonionic reactive surfactants include alkyl ether surfactants (examples of commercially available products include ADEKA REASOAP ER-10, ER-20, ER-30, and ER-40 manufactured by ADEKA CORPORATION, LATEMUL PD-420, PD-430, and PD-450 manufactured by Kao Corporation, and others); alkyl phenyl ether surfactants or alkyl phenyl ester surfactants (examples of commercially available products include AQUALON RN-10, RN-20, RN-30, and RN-50 manufactured by Dai-ichi Kogyo Seiyaku Co., Ltd., ADEKA REASOAP NE-10, NE-20, NE-30, and NE-40 manufactured by ADEKA CORPORATION, and others); and (meth)acrylate sulfate ester surfactants (examples of commercially available products include RMA-564, RMA-568, and RMA-1114 manufactured by Nippon Nyukazai Co., Ltd, and others).

The reactive surfactant is used at a content of 0.3 to 3 parts by weight based on 100 parts by weight of the monomer mixture. If the content of the reactive surfactant is less than 0.3 parts by weight, the pressure-sensitive adhesive layer can have a low saturated water absorption, so that it will be relatively hard and more likely to peel in a high-humidity environment and therefore cannot have satisfactory moisture durability. In addition, the polymerization stability can be low during the emulsion polymerization. If the content of the reactive surfactant is more than 3 parts by weight, the pressure-sensitive adhesive layer can have a high saturated water absorption, and a relatively large amount of water can be expanded and vaporized from the pressure-sensitive adhesive layer, so that foaming will be more likely to occur and therefore satisfactory heat durability cannot be achieved. The content of the reactive surfactant is preferably from 0.3 to less than 2 parts by weight.

The radical polymerization initiator may be, but not limited to, any known radical polymerization initiator commonly used in emulsion polymerization. Examples include azo initiators such as 2,2′-azobisisobutylonitrile, 2,2′-azobis(2-methylpropionamidine)disulfate, 2,2′-azobis(2-methylpropionamidine)dihydrochloride, 2,2′-azobis(2-amidinopropane)dihydrochloride, and 2,2′-azobis[2-(2-imidazoline-2-yl)propane]dihydrochloride; persulfate initiators such as potassium persulfate and ammonium persulfate; peroxide initiators such as benzoyl peroxide, tert-butyl hydroperoxide, and hydrogen peroxide; substituted ethane initiators such as phenyl-substituted ethane; and carbonyl initiators such as aromatic carbonyl compounds. These polymerization initiators maybe appropriately used alone or in any combination. If desired, the emulsion polymerization may be performed using a redox system initiator, in which a reducing agent is used in combination with the polymerization initiator. This makes it easy to accelerate the emulsion polymerization rate or to perform the emulsion polymerization at low temperature. Examples of such a reducing agent include reducing organic compounds such as ascorbic acid, erythorbic acid, tartaric acid, citric acid, glucose, and metal salts of formaldehyde sulfoxylate or the like; reducing inorganic compounds such as sodium thiosulfate, sodium sulfite, sodium bisulfite, and sodium metabisulfite; and ferrous chloride, Rongalite, and thiourea dioxide.

The content of the radical polymerization initiator is typically from about 0.02 to about 1 part by weight, preferably from 0.02 to 0.5 parts by weight, more preferably from 0.08 to 0.3 parts by weight, based on 100 parts by weight of the monomer mixture, while it is appropriately selected. If it is less than 0.02 parts by weight, the radical polymerization initiator may be less effective. If it is more than 1 part by weight, the (meth)acryl-based polymer in the aqueous dispersion (polymer emulsion) may have a reduced molecular weight, so that the aqueous dispersion-type pressure-sensitive adhesive may have reduced durability. In the case of a redox system initiator, the reducing agent is preferably used in an amount of 0.01 to 1 part by weight based on 100 parts by weight of the total amount of the monomer mixture.

A chain transfer agent is optionally used to control the molecular weight of the (meth)acryl-based polymer in the aqueous dispersion (polymer emulsion). In general, chain transfer agents commonly used in emulsion polymerization are used. Examples include 1-dodecanthiol, mercaptoacetic acid, 2-mercaptoethanol, 2-ethylhexyl thioglycolate, 2,3-dimercapto-1-propanol, mercaptopropionic acid esters, and other mercaptans. These chain transfer agents may be appropriately used alone or in any combination. For example, the content of the chain transfer agent is from 0.001 to 0.3 parts by weight based on 100 parts by weight of the monomer mixture.

Such emulsion polymerization makes it possible to prepare the (meth)acryl-based polymer in the form of an emulsion. The average particle size of such an emulsion-type (meth)acryl-based polymer is typically adjusted to 0.05 μm to 3 μm, and preferably to 0.05 μm to 1 μm. If the average particle size is less than 0.05 μm, the viscosity of the aqueous dispersion-type pressure-sensitive adhesive can increase in some cases, and if it is more than 1 μm, adhesiveness between particles can decrease so that cohesive strength can decrease in some cases.

When the (meth)acryl-based polymer that is contained in the emulsion has the carboxyl group-containing monomer or the like as the copolymerizable monomer for maintaining the stability of the aqueous dispersion, the carboxyl group-containing monomer should preferably be neutralized. For example, the neutralization can be performed using ammonia, an alkali metal hydroxide, or the like.

In general, the emulsion-type (meth)acryl-based polymer according to the present invention preferably has a weight average molecular weight of 1,000,000 or more. In particular, the weight average molecular weight is preferably from 1,000,000 to 4,000,000 in view of heat resistance or moisture resistance. A weight average molecular weight of less than 1,000,000 is not preferred, because with such a molecular weight, heat resistance or moisture resistance may decrease. The pressure-sensitive adhesive obtained by the emulsion polymerization is preferred because the polymerization mechanism can produce very high molecular weight. It should be noted, however, that the pressure-sensitive adhesive obtained by the emulsion polymerization generally has a high gel content and cannot be subjected to GPC (gel permeation chromatography) measurement, which means that it is often difficult to identify the molecular weight by actual measurement.

The aqueous dispersion-type pressure-sensitive adhesive of the present invention, which includes an emulsion containing the (meth)acryl-based polymer, may contain a crosslinking agent. Examples of the crosslinking agent at maybe used include those commonly used, such as an isocyanate crosslinking agent, an epoxy crosslinking agent, an oxazoline crosslinking agent, an aziridine crosslinking agent, a carbodiimide crosslinking agent, and a metal chelate crosslinking agent. When a functional group-containing monomer is used, these crosslinking agents have the effect of reacting with the functional group incorporated in the (meth)acryl-based polymer to form crosslinkage.

The content of the crosslinking agent added to the (meth)acryl-based polymer is generally, but not limited to, about 10 parts by weight or less (solid basis) based on 100 parts by weight (solid basis) of the (meth)acryl-based polymer. The content of the crosslinking agent is preferably from 0.001 to 10 parts by weight, and more preferably from 0.01 to 5 parts by weight.

If necessary, the aqueous dispersion-type pressure-sensitive adhesive of the present invention may further appropriately contain any of various additives such as viscosity adjusting agent, releasing adjusting agent, tackifiers, plasticizers, softener, fillers including glass fibers, glass beads, metal power, or any other inorganic powder, pigments, colorants(pigments, dyes or the likes), pH adjusting agent(acid or base), antioxidants, and ultraviolet ray absorbing agents, silane coupling agents, without departing from the objects of the present invention. The aqueous dispersion-type pressure-sensitive adhesive may also contain fine particles to form a light-diffusing pressure-sensitive adhesive layer. These additives may also be added in the form of emulsion.

The pressure-sensitive adhesive layer for an optical film of the present invention is made from the aqueous dispersion-type pressure-sensitive adhesive. The pressure-sensitive adhesive layer can be formed by a process including applying the aqueous dispersion-type pressure-sensitive adhesive to a substrate (an optical film or a release film) and then drying the adhesive.

The pressure-sensitive adhesive optical film of the present invention includes an optical film and the pressure-sensitive adhesive layer or layers placed on one or both sides of the optical film. The pressure-sensitive adhesive optical film of the present invention can be formed by a process including applying the aqueous dispersion-type pressure-sensitive adhesive to an optical film or a release film and drying the composition. When the pressure-sensitive adhesive layer is formed on a release film, the pressure-sensitive adhesive layer will be transferred and bonded to an optical film.

Various methods maybe used in the applying step of the aqueous dispersion-type pressure-sensitive adhesive. Examples include roll coating, kiss roll coating, gravure coating, reverse coating, roll brush coating, spray coating, dip roll coating, bar coating, knife coating, air knife coating, curtain coating, lip coating, and extrusion coating using a die coater or the like.

In the applying step, the amount of the application should be controlled so that a pressure-sensitive adhesive layer with a predetermined thickness (post-drying thickness) can be formed. The thickness (post-drying thickness) of the pressure-sensitive adhesive layer is generally set within the range of about 1 μm to about 100 μm, preferably within the range of 5 to 50 μm, and more preferably within the range of 10 μm to 40 μm.

Subsequently, the applied aqueous dispersion-type pressure-sensitive adhesive is dried to form a pressure-sensitive adhesive layer. The drying temperature is generally from about 80 to about 170° C., preferably from 80 to 160° C., and the drying time period is generally from about 0.5 to about 30 minutes, preferably from 1 to 10 minutes.

Preferably, the pressure-sensitive adhesive layer has an elongation percentage (L60) of 200% or less in an environment at 60° C. and 7% R.H. and has a ratio {(L60−90)/(L60)} of an elongation percentage (L60−90) in an environment at 60° C. and 90% R.H. to an elongation percentage (L60) in an environment at 60° C. and 7% R.H. of 1.5 or more as measured by the method described above. The measurement method is described in detail in the section of examples below. The elongation percentage (L60) is preferably 200% or less, and more preferably 150% or less. When the elongation percentage (L60) is 200% or less, the pressure-sensitive adhesive layer can have good cohesive strength, which is preferred in order to suppress peeling over time. The ratio {(L60−90)/(L60)} is preferably 1.8 or more, and more preferably 2 or more. When the ratio is 1.5 or more, the pressure-sensitive adhesive layer can resist softening under moist conditions, which is preferred in order to suppress moisture-induced peeling, which would otherwise occur due to a reduction in adhesive strength.

Examples of the material used to form the release film. include a plastic film such as a polyethylene, polypropylene, polyethylene terephthalate, or polyester film, a porous material such as paper, fabric, or nonwoven fabric, and an appropriate thin material such as a net, a foamed sheet, a metal foil, and a laminate thereof. A plastic film is preferably used, because of its good surface smoothness.

Any plastic film capable of protecting the pressure-sensitive adhesive layer may be used, examples of which include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, and an ethylene-vinyl acetate copolymer film.

The thickness of the release film is generally from about 5 to about 200 μm, preferably from about 5 to about 100 μm. If necessary, the separator may be subjected to a release treatment and an antifouling treatment with a silicone, fluoride, long-chain alkyl, or fatty acid amide release agent, silica powder or the like, or subjected to an antistatic treatment of coating type, kneading and mixing type, vapor-deposition type, or the like. In particular, when the surface of the release film is appropriately subjected to a release treatment such as a silicone treatment, a long-chain alkyl treatment, or a fluorine treatment, the releasability from the pressure-sensitive adhesive layer can be further increased.

The pressure-sensitive adhesive layer may be exposed. In such a case, the pressure-sensitive adhesive layer may be protected by the release film until it is actually used. The release film may be used as is as a separator for a pressure-sensitive adhesive optical film, so that the process can be simplified.

An optical film may also be coated with an anchor layer or subjected to any adhesion-facilitating treatment such as a corona treatment or a plasma treatment so as to have improved adhesion to a pressure-sensitive adhesive layer, and then the pressure-sensitive adhesive layer may be formed. The surface of the pressure-sensitive adhesive layer may also be subjected to an adhesion-facilitating treatment.

Materials that maybe used to form the anchor layer preferably include an anchoring agent selected from polyurethane, polyester, polymers containing an amino group in the molecule, and polymers containing an oxazolinyl group in the molecule, in particular, preferably polymers containing an amino group in the molecule and polymers containing an oxazolinyl group in the molecule. Polymers containing an amino group in the molecule and polymers containing an oxazolinyl group in the molecule allow the amino group in the molecule or an oxazolinyl group in the molecule to react with a carboxyl group or the like in the pressure-sensitive adhesive or to make an interaction such as an ionic interaction, so that good adhesion can be ensured.

Examples of polymers containing an amino group in the molecule include polyethyleneimine, polyallylamine, polyvinylamine, polyvinylpyridine, polyvinylpyrrolidine, and a polymer of an amino group-containing monomer such as dimethylaminoethyl acrylate.

The optical film for use in the pressure-sensitive adhesive optical film of the present invention may be one used to form an image display such as a liquid crystal display. The type of the optical film is preferably, but not limited to, that having a moisture permeability of 1,000 g/m² per 24 hours at 80° C. and 90% R.H. or less. In particular, the present invention is preferably carried out using a material with a moisture permeability of 800 g/m² per 24 hours or less, more preferably 500 g/m² per 24 hours or less, and even more preferably 200 g/m² per 24 hours or less.

Examples of materials with such a moisture permeability that may be used include (meth)acryl-based polymers; polycarbonate polymers; arylate polymers; polyester polymers such as polyethylene terephthalate and polyethylene naphthalate; amide polymers such as nylon and aromatic polyamides; polyolefin polymers such as polyethylene, polypropylene, and ethylene-propylene copolymers; cyclo system- or norbornene structure-containing cyclic olefin resins; and any mixtures thereof.

Examples thereof also include the polymer film disclosed in JP-A-2001-343529 (W001/37007) such as a film of a resin composition containing (A) a thermoplastic resin having a substituted and/or unsubstituted imide group in the side chain and (B) a thermoplastic resin having a substituted and/or unsubstituted phenyl and nitrile groups in the side chain. A specific example includes a film of a resin composition containing an alternating copolymer of isobutylene and N-methylmaleimide and an acrylonitrile-styrene copolymer. Films such as those produced by mixing and extrusion of the resin composition may be used.

Among the above materials, cyclic olefin resins are preferred. Cyclic olefin resin is a generic name for such resins as those disclosed in JP-A-03-14882 and JP-A-03-122137. Specific examples thereof include ring-opened polymers of cyclic olefins, addition polymers of cyclic olefins, random copolymers of cyclic olefins and a-olefins such as ethylene and propylene, and graft polymers produced by modification thereof with unsaturated carboxylic acids or derivatives thereof. Specific examples also include hydrides thereof. Examples of cyclic olefins include, but are not limited to, norbornene, tetracyclododecen, and derivatives thereof. Commercially available products thereof include ZEONEX and ZEONOR series manufactured by ZEON CORPORATION, ARTON series manufactured by JSR Corporation, and TOPAS series manufactured by Ticona.

For example, the optical film made of the low moisture permeability material is used as a transparent protective film for a polarizer, a retardation film, or the like.

For example, the optical film for use in the pressure-sensitive adhesive optical film of the present invention may be a polarizing plate. A polarizing plate including a polarizer and a transparent protective film or films provided on one or both sides of the polarizer is generally used.

A polarizer is, but not limited to, various kinds of polarizer may be used. As a polarizer, for example, a film that is uniaxially stretched after having dichromatic substances, such as iodine and dichromatic dye, absorbed to hydrophilic polymer films, such as polyvinyl alcohol-based film, partially formalized polyvinyl alcohol-based film, and ethylene-vinyl acetate copolymer-based partially saponified film; polyene-based alignment films, such as dehydrated polyvinyl alcohol and dehydrochlorinated polyvinyl chloride, etc. may be mentioned. In these, a polyvinyl alcohol-based film on which dichromatic materials such as iodine, is absorbed and aligned after stretched is suitably used. Thickness of polarizer is, but not limited to, generally about 5 to about 80 μm.

A polarizer that is uniaxially stretched after a polyvinyl alcohol-based film dyed with iodine is obtained by stretching a polyvinyl alcohol film by 3 to 7 times the original length, after dipped and dyed in aqueous solution of iodine. If needed the film may also be dipped in aqueous solutions, such as boric acid and potassium iodide, which may include zinc sulfate, zinc chloride. Furthermore, before dyeing, the polyvinyl alcohol-based film may be dipped in water and rinsed if needed. By rinsing polyvinyl alcohol-based film with water, effect of preventing un-uniformity, such as unevenness of dyeing, is expected by making polyvinyl alcohol-based film swelled in addition that also soils and blocking inhibitors on the polyvinyl alcohol-based film surface may be washed off. Stretching may be applied after dyed with iodine or may be applied concurrently, or conversely dyeing with iodine may be applied after stretching. Stretching is applicable in aqueous solutions, such as boric acid and potassium iodide, and in water bath.

A thermoplastic resin with a high level of transparency, mechanical strength, thermal stability, moisture blocking properties, isotropy, and the like may be used as a material for forming the transparent protective film. Examples of such a thermoplastic resin include cellulose resins such as triacetylcellulose, polyester resins, polyethersulfone resins, polysulfone resins, polycarbonate resins, polyamide resins, polyimide resins, polyolefin resins, (meth)acrylic resins, cyclic olefin polymer resins (norbornene resins), polyarylate resins, polystyrene resins, polyvinyl alcohol resins, and any mixture thereof. The transparent protective film is generally laminated to one side of the polarizer with the adhesive layer, but thermosetting resins or ultraviolet curing resins such as (meth)acrylic, urethane, acrylic urethane, epoxy, or silicone resins may be used to other side of the polarizer for the transparent protective film. The transparent protective film may also contain at least one type of any appropriate additive. Examples of the additive include an ultraviolet absorbing agent, an antioxidant, a lubricant, a plasticizer, a release agent, an anti-discoloration agent, a flame retardant, a nucleating agent, an antistatic agent, a pigment, and a colorant. The content of the thermoplastic resin in the transparent protective film is preferably from 50 to 100% by weight, more preferably from 50 to 99% by weight, still more preferably from 60 to 98% byweight, particularly preferably from 70 to 97% by weight. If the content of the thermoplastic resin in the transparent protective film is 50% by weight or less, high transparency and other properties inherent in the thermoplastic resin can fail to be sufficiently exhibited.

An optical film may be exemplified as other optical layers, such as a reflective plate, a transflective plate, a retardation plate (a half wavelength plate and a quarter wavelength plate included), a viewing angle compensation film, a brightness enhancement film, a surface treatment film or the like, which may be used for formation of a liquid crystal display etc. These are used in practice as an optical film, or as one layer or two layers or more of optical layers laminated with polarizing plate.

The surface treatment film may also be provided on and bonded to a front face plate. Examples of the surface treatment film include a hard-coat film for use in imparting scratch resistance to the surface, an antiglare treatment film for preventing glare on image displays, and an anti-reflection film such as an anti-reflective film or a low-reflective film, etc. The front face plate is provided on and bonded to the surface of an image display such as a liquid crystal display, an organic EL display, a CRT, or a PDP to protect the image display or to provide a high-grade appearance or a differentiated design. The front face plate is also used as a support for a λ/4 plate in a 3D-TV. In a liquid crystal display, for example, the front face plate is provided above a polarizing plate on the viewer side. When the pressure-sensitive adhesive layer according to the present invention is used, the same effect can be produced using a plastic base material such as a polycarbonate or poly (methyl methacrylate) base material for the front face plate, as well as using a glass base material.

Although an optical film with the above described optical layer laminated to the polarizing plate may be formed by a method in which laminating is separately carried out sequentially in manufacturing process of a liquid crystal display or the like, an optical film in a form of being laminated beforehand has an outstanding advantage that it has excellent stability in quality and assembly workability, and thus manufacturing processes ability of a liquid crystal display or the like may be raised. Proper adhesion means, such as a pressure-sensitive adhesive layer, may be used for laminating. On the occasion of adhesion of the above described polarizing plate and other optical films, the optical axis may be set as a suitable configuration angle according to the target retardation characteristics or the like.

The pressure-sensitive adhesive optical film of the present invention is preferably used to form various types of image displays such as liquid crystal displays. Liquid crystal displays may be produced according to conventional techniques. Specifically, liquid crystal displays are generally produced by appropriately assembling a display panel such as a liquid crystal cell and the pressure-sensitive adhesive optical film and optionally other components such as a lighting system and incorporating a driving circuit according to any conventional technique, except that the pressure-sensitive adhesive optical film of the present invention is used. Any type of liquid crystal cell may also be used such as a TN type, an STN type, a n type, a VA type and an IPS type.

Suitable liquid crystal displays, such as liquid crystal display with which the above pressure-sensitive adhesive optical film has been provided on one side or both sides of the display panel such as a liquid crystal cell, and with which a backlight or a reflective plate is used for a lighting system may be manufactured. In this case, the pressure-sensitive adhesive optical film of the present invention may be provided on one side or both sides of the display panel such as a liquid crystal cell. When providing the pressure-sensitive adhesive optical films on both sides, they may be of the same type or of different type. Furthermore, in assembling a liquid crystal display, suitable parts, such as diffusion plate, anti-glare layer, antireflection film, protective plate, prism array, lens array sheet, optical diffusion plate, and backlight, may be installed in suitable position in one layer or two or more layers.

Subsequently, organic electro luminescence equipment (organic EL display: OLED) will be explained. Generally, in organic EL display, a transparent electrode, an organic luminescence layer and a metal electrode are laminated on a transparent substrate in an order configuring an illuminant (organic electro luminescence illuminant). Here, a organic luminescence layer is a laminated material of various organic thin films, and much compositions with various combination are known, for example, a laminated material of hole injection layer including triphenylamine derivatives etc., a luminescence layer including fluorescent organic solids, such as anthracene; a laminated material of electronic injection layer including such a luminescence layer and perylene derivatives, etc.; laminated material of these hole injection layers, luminescence layer, and electronic injection layer etc.

An organic EL display emits light based on a principle that positive hole and electron are injected into an organic luminescence layer by impressing voltage between a transparent electrode and a metal electrode, the energy produced by recombination of these positive holes and electrons excites fluorescent substance, and subsequently light is emitted when excited fluorescent substance returns to ground state. A mechanism called recombination which takes place in an intermediate process is the same as a mechanism in common diodes, and, as is expected, there is a strong non-linear relationship between electric current and luminescence strength accompanied by rectification nature to applied voltage.

In an organic EL display, in order to take out luminescence in an organic luminescence layer, at least one electrode must be transparent. The transparent electrode usually formed with transparent electric conductor, such as indium tin oxide (ITO), is used as an anode. On the other hand, in order to make electronic injection easier and to increase luminescence efficiency, it is important that a substance with small work function is used for cathode, and metal electrodes, such as Mg—Ag and Al—Li, are usually used.

In organic EL display of such a configuration, an organic luminescence layer is formed by a very thin film about 10 nm in thickness. For this reason, light is transmitted nearly completely through organic luminescence layer as through transparent electrode. Consequently, since the light that enters, when light is not emitted, as incident light from a surface of a transparent substrate and is transmitted through a transparent electrode and an organic luminescence layer and then is reflected by a metal electrode, appears in front surface side of the transparent substrate again, a display side of the organic EL display looks like mirror if viewed from outside.

In an organic EL display containing an organic electro luminescence illuminant equipped with a transparent electrode on a surface side of an organic luminescence layer that emits light by impression of voltage, and at the same time equipped with a metal electrode on a back side of organic luminescence layer, a retardation plate may be installed between these transparent electrodes and a polarization plate, while preparing the polarization plate on the surface side of the transparent electrode.

Since the retardation plate and the polarization plate have function polarizing the light that has entered as incident light from outside and has been reflected by the metal electrode, they have an effect of making the mirror surface of metal electrode not visible from outside by the polarization action. If a retardation plate is configured with a quarter wavelength plate and the angle between the two polarization directions of the polarization plate and the retardation plate is adjusted to π/4, the mirror surface of the metal electrode may be completely covered.

This means that only linearly polarized light component of the external light that enters as incident light into this organic EL display is transmitted with the work of polarization plate. This linearly polarized light generally gives an elliptically polarized light by the retardation plate, and especially the retardation plate is a quarter wavelength plate, and moreover when the angle between the two polarization directions of the polarization plate and the retardation plate is adjusted to π/4, it gives a circularly polarized light.

This circularly polarized light is transmitted through the transparent substrate, the transparent electrode and the organic thin film, and is reflected by the metal electrode, and then is transmitted through the organic thin film, the transparent electrode and the transparent substrate again, and is turned into a linearly polarized light again with the retardation plate. And since this linearly polarized light lies at right angles to the polarization direction of the polarization plate, it cannot be transmitted through the polarization plate. As the result, mirror surface of the metal electrode may be completely covered.

As described above, in order to block mirror reflection, the organic EL panel of an organic EL display may use an elliptically or circularly polarizing plate having a combination of a retardation plate and a polarizing plate with the pressure-sensitive adhesive layer interposed therebetween. Alternatively, without an elliptically or circularly polarizing plate directly bonded to an organic EL panel, a laminate formed by bonding an elliptically or circularly polarizing plate to a touch panel with the pressure-sensitive adhesive layer interposed therebetween may be used in an organic EL panel.

The present invention is applicable to various types of touch panel, such as optical, ultrasonic, capacitance, and resistive touch panels. A resistive touch panel includes: a touch-side, touch panel-forming electrode plate having a transparent conductive thin film; and a display-side, touch panel-forming electrode plate having a transparent conductive thin film, wherein the electrode plates are opposed to each other with spacers interposed therebetween in such a manner that the transparent conductive thin films are opposed to each other. A capacitance touch panel generally includes a transparent conductive film that has a transparent conductive thin film in a specific pattern and is formed over the surface of a display unit. The pressure-sensitive adhesive-type optical film according to the present invention may be used on any of the touch side and the display side.

### EXAMPLES

Hereinafter, the present invention is more specifically described with reference to the examples, which however are not intended to limit the present invention. In each example, “parts” and “%” are all by weight.

### (Preparation of Polarizing Plate)

An 80 μm thick polyvinyl alcohol film was stretched to 3 times between rolls different in velocity ratio, while it was dipped in a 0.3% iodine aqueous solution at 30° C. The film was then stretched to a total stretch ratio of 6 times in an aqueous solution containing 4% boric acid and 10% potassium iodide at 60° C. Subsequently, the film was washed by immersion in an aqueous solution of 1.5% potassium iodide at 30° C. for 10 seconds and then dried at 50° C. for 4 minutes to give a polarizer. An 80 μm thick saponified triacetylcellulose film was bonded to one side of the polarizer with a polyvinyl alcohol-based adhesive. A70 μm thick cyclic olefin resin film (ZEONOR (trade name), manufactured by ZEON CORPORATION) was bonded to the other side of the polarizer with a polyvinyl alcohol-based adhesive. The cyclic olefin resin film had a moisture permeability of 127 g/m² per 24 hours at 80° C. and 90% R.H.

### (Moisture Permeability)

The moisture permeability was measured by the moisture permeability test (cup method) according to JIS Z 0208. A sample (of the above transparent protective film) with a diameter of 60 mm obtained by cutting was placed in a moisture -permeable cup containing about 15 g of calcium chloride. The cup was placed in a thermostat at 80° C. and 90% R.H. and allowed to stand for 24 hours. Subsequently, the moisture permeability (g/m² per 24 hours) was determined by measuring the increase in the weight of the calcium chloride.

### Example 1

### (Preparation of Monomer Emulsion)

To a vessel were added 780 parts of butyl acrylate, 200 parts of methyl methacrylate, and 20 parts of acrylic acid, and mixed, so that a monomer mixture was obtained. Subsequently, 4 parts of AQUALON HS-10 (manufactured by Dai-ichi Kogyo Seiyaku Co., Ltd.) as a reactive surfactant and 635 parts of ion-exchanged water were added to 1,000 parts of the monomer mixture prepared with the above composition, and stirred at 6,000 (rpm) for 5 minutes using a homomixer (manufactured by PRIMIX Corporation), so that a monomer emulsion was obtained.

### (Preparation of Emulsion-Type Acryl-Based Pressure-Sensitive Adhesive)

To a reaction vessel equipped with a condenser tube, a nitrogen-introducing tube, a thermometer, a dropping funnel, and a stirring blade were added 200 parts of a portion of the monomer emulsion prepared as described above and 515.9 parts of ion-exchanged water. Subsequently, after the space in the reaction vessel was replaced with nitrogen gas sufficiently, 0.6 parts of ammonium persulfate was added to the vessel, and the mixture was subjected to polymerization at 60° C. for 1 hour with stirring. Subsequently, the remaining portion of the monomer emulsion was added dropwise to the reaction vessel over 3 hours, while the reaction vessel was kept at 60° C. The mixture was then subjected to polymerization for 3 hours, so that a polymer emulsion with a solid concentration of 46.2% was obtained. Subsequently, after the polymer emulsion was cooled to room temperature, 10% ammonia water was added thereto, so that an emulsion-type acryl-based pressure-sensitive adhesive was obtained, whose pH and solid concentration were adjusted to 8 and 45.6%, respectively.

### (Formation of Pressure-Sensitive Adhesive Layer and Preparation of Pressure-Sensitive Adhesive-Type Polarizing Plate)

The emulsion-type acryl-based pressure-sensitive adhesive was applied to a release film (Diafoil MRF-38, manufactured by Mitsubishi Chemical Polyester Co., Ltd., a polyethylene terephthalate backing) with a die coater so that a 20 μm thick coating could be formed after drying, and then the coating was dried at 120° C. for 5 minutes to form a pressure-sensitive adhesive layer. The pressure-sensitive adhesive layer was bonded to one side of the polarizing plate (the cyclic olefin resin film side), so that a pressure-sensitive adhesive-type polarizing plate was obtained.

### Example 2

A monomer emulsion was prepared as in Example 1, except that the amount of AQUALON HS-10 (manufactured by Dai-ichi Kogyo Seiyaku Co., Ltd.) used as a reactive surfactant was changed to 10 parts. An emulsion-type acryl-based pressure-sensitive adhesive, a pressure-sensitive adhesive layer, and a pressure-sensitive adhesive-type polarizing plate were also prepared as in Example 1, except that the resulting monomer emulsion was used instead.

### Example 3

A monomer emulsion was prepared as in Example 1, except that the amount of AQUALON HS-10 (manufactured by Dai-ichi Kogyo Seiyaku Co., Ltd.) used as a reactive surfactant was changed to 19 parts. An emulsion-type acryl-based pressure-sensitive adhesive, a pressure-sensitive adhesive layer, and a pressure-sensitive adhesive-type polarizing plate were also prepared as in Example 1, except that the resulting monomer emulsion was used instead.

### Example 4

A monomer emulsion was prepared as in Example 1, except that the amount of AQUALON HS-10 (manufactured by Dai-ichi Kogyo Seiyaku Co., Ltd.) used as a reactive surfactant was changed to 30 parts. An emulsion-type acryl-based pressure-sensitive adhesive, a pressure-sensitive adhesive layer, and a pressure-sensitive adhesive-type polarizing plate were also prepared as in Example 1, except that the resulting monomer emulsion was used instead.

### Examples 5 to 10

### (Preparation of Monomer Emulsions)

Each monomer mixture was obtained as in Example 1, except that in the preparation of 1,000 parts of the monomer mixture, the composition of the monomers in the monomer mixture was changed as shown in Table 1 (it should be noted that the monomer composition is expressed by a weight ratio (%) in Table 1). Subsequently, 19 parts of AQUALON HS-10 (manufactured by Dai-ichi Kogyo Seiyaku Co., Ltd.) as a reactive surfactant and 635 parts of ion-exchanged water were added to 1,000 parts of the monomer mixture prepared with the above composition, and stirred at 6,000 (rpm) for 5 minutes using a homomixer (manufactured by PRIMIX Corporation), so that each monomer emulsion was obtained.

Emulsion-type acryl-based pressure-sensitive adhesives, pressure-sensitive adhesive layers, and pressure-sensitive adhesive-type polarizing plate were also prepared as in Example 1, except that the each resulting monomer emulsion was used instead.

### Example 11

### (Preparation of Monomer Emulsion)

To a vessel were added 975 parts of butyl acrylate, 5 parts of 3-methacryloyloxypropyl-triethoxysilane (KBM-503, manufactured by Shin-Etsu Chemical Co., Ltd.), and 20 parts of acrylic acid, and mixed, so that a monomer mixture was obtained. Subsequently, 5 parts of AQUALON HS-10 (manufactured by Dai-ichi Kogyo Seiyaku Co., Ltd.) as a reactive surfactant and 635 parts of ion-exchanged water were added to 1,000 parts of the monomer mixture prepared with the above composition, and stirred at 6,000 (rpm) for 5 minutes using a homomixer (manufactured by PRIMIX Corporation), so that a monomer emulsion was obtained.

An emulsion-type acryl-based pressure-sensitive adhesive, a pressure-sensitive adhesive layer, and a pressure-sensitive adhesive-type polarizing plate were also prepared as in Example 1, except that the resulting monomer emulsion was used instead.

### Example 12

A monomer emulsion was prepared as in Example 11, except that the amount of AQUALON HS-10 (manufactured by Dai-ichi Kogyo Seiyaku Co., Ltd.) used as a reactive surfactant was changed to 19 parts. An emulsion-type acryl-based pressure-sensitive adhesive, a pressure-sensitive adhesive layer, and a pressure-sensitive adhesive-type polarizing plate were also prepared as in Example 11, except that the resulting monomer emulsion was used instead.

### Example 13

A monomer emulsion was prepared as in Example 11, except that the amount of AQUALON HS-10 (manufactured by Dai-ichi Kogyo Seiyaku Co., Ltd.) used as a reactive surfactant was changed to 30 parts. An emulsion-type acryl-based pressure-sensitive adhesive, a pressure-sensitive adhesive layer, and a pressure-sensitive adhesive-type polarizing plate were also prepared as in Example 11, except that the resulting monomer emulsion was used instead.

### Example 14 to 17

### (Preparation of Monomer Emulsions)

Each monomer mixture was obtained as in Example 11, except that in the preparation of 1,000 parts of the monomer mixture, the composition of the monomers in the monomer mixture was changed as shown in Table 1 (it should be noted that the monomer composition is expressed by a weight ratio (%) in Table 1). Subsequently, 19 parts of AQUALON HS-10 (manufactured by Dai-ichi Kogyo Seiyaku Co., Ltd.) as a reactive surfactant and 635 parts of ion-exchanged water were added to 1,000 parts of the monomer mixture prepared with the above composition, and stirred at 6,000 (rpm) for 5 minutes using a homomixer (manufactured by PRIMIX Corporation), so that each monomer emulsion was obtained.

Emulsion-type acryl-based pressure-sensitive adhesives, pressure-sensitive adhesive layers, and pressure-sensitive adhesive-type polarizing plate were also prepared as in Example 11, except that the each resulting monomer emulsion was used instead.

### Example 18

### (Preparation of Monomer Emulsion)

To a vessel were added 779.5 parts of butyl acrylate, 200 parts of methyl methacrylate, 0.5 parts of 3-methacryloyloxypropyl-trimethoxysilane (KBM-503, manufactured by Shin-Etsu Chemical Co., Ltd.), and 20 parts of acrylic acid, and mixed, so that a monomer mixture was obtained. Subsequently, 5 parts of AQUALON HS-10 (manufactured by Dai-ichi Kogyo Seiyaku Co., Ltd.) as a reactive surfactant and 635 parts of ion-exchanged water were added to 1,000 parts of the monomer mixture prepared with the above composition, and stirred at 6,000 (rpm) for 5 minutes using a homomixer (manufactured by PRIMIX Corporation), so that a monomer emulsion was obtained.

An emulsion-type acryl-based pressure-sensitive adhesive, a pressure-sensitive adhesive layer, and a pressure-sensitive adhesive-type polarizing plate were also prepared as in Example 1, except that the resulting monomer emulsion was used instead.

### Example 19

A monomer emulsion was prepared as in Example 18, except that the amount of AQUALON HS-10 (manufactured by Dai-ichi Kogyo Seiyaku Co., Ltd.) used as a reactive surfactant was changed to 19 parts. An emulsion-type acryl-based pressure-sensitive adhesive, a pressure-sensitive adhesive layer, and a pressure-sensitive adhesive-type polarizing plate were also prepared as in Example 18, except that the resulting monomer emulsion was used instead.

### Example 20

A monomer emulsion was prepared as in Example 18, except that the amount of AQUALON HS-10 (manufactured by Dai-ichi Kogyo Seiyaku Co., Ltd.) used as a reactive surfactant was changed to 30 parts. An emulsion-type acryl-based pressure-sensitive adhesive, a pressure-sensitive adhesive layer, and a pressure-sensitive adhesive-type polarizing plate were also prepared as in Example 18, except that the resulting monomer emulsion was used instead.

### Example 21 to 27

### (Preparation of Monomer Emulsions)

Each monomer mixture was obtained as in Example 18, except that in the preparation of 1,000 parts of the monomer mixture, the composition of the monomers in the monomer mixture was changed as shown in Table 1 (it should be noted that the monomer composition is expressed by a weight ratio (%) in Table 1). Subsequently, 19 parts of AQUALON HS-10 (manufactured by Dai-ichi Kogyo Seiyaku Co., Ltd.) as a reactive surfactant and 635 parts of ion-exchanged water were added to 1,000 parts of the monomer mixture prepared with the above composition, and stirred at 6,000 (rpm) for 5 minutes using a homomixer (manufactured by PRIMIX Corporation), so that each monomer emulsion was obtained.

Emulsion-type acryl-based pressure-sensitive adhesives, pressure-sensitive adhesive layers, and pressure-sensitive adhesive-type polarizing plate were also prepared as in Example 18, except that the each resulting monomer emulsion was used instead.

### Comparative Example 1

A monomer emulsion was prepared as in Example 1, except that 25 parts of EMAL 10 (manufactured by Kao Corporation), a non-reactive surfactant, was used in place of 4 parts of AQUALON HS-10 (manufactured by Dai-ichi Kogyo Seiyaku Co., Ltd.), a reactive surfactant. An emulsion-type acryl-based pressure-sensitive adhesive, a pressure-sensitive adhesive layer, and a pressure-sensitive adhesive-type polarizing plate were also prepared as in Example 1, except that the resulting monomer emulsion was used instead.

### Comparative Example 2

A monomer emulsion was prepared as in Example 1, except that the amount of AQUALON HS-10 (manufactured by Dai-ichi Kogyo Seiyaku Co., Ltd.) used as a reactive surfactant was changed to 60 parts. An emulsion-type acryl-based pressure-sensitive adhesive, a pressure-sensitive adhesive layer, and a pressure-sensitive adhesive-type polarizing plate were also prepared as in Example 1, except that the resulting monomer emulsion was used instead.

### Comparative Example 3

A monomer emulsion was prepared as in Example 1, except that the amount of AQUALON HS-10 (manufactured by Dai-ichi Kogyo Seiyaku Co., Ltd.) used as a reactive surfactant was changed to 2 parts. An emulsion-type acryl-based pressure-sensitive adhesive, a pressure-sensitive adhesive layer, and a pressure-sensitive adhesive-type polarizing plate were also prepared as in Example 1, except that the resulting monomer emulsion was used instead.

### Comparative Example 4

A monomer emulsion was prepared as in Example 1, except that 2 parts of EMAL 10 (manufactured by Kao Corporation), a non-reactive surfactant, was used in place of 4 parts of AQUALON HS-10 (manufactured by Dai-ichi Kogyo Seiyaku Co., Ltd.), a reactive surfactant. An emulsion-type acryl-based pressure-sensitive adhesive, a pressure-sensitive adhesive layer, and a pressure-sensitive adhesive-type polarizing plate were also prepared as in Example 1, except that the resulting monomer emulsion was used instead.

### Comparative Example 5

A monomer emulsion was prepared as in Example 11, except that the amount of AQUALON HS-10 (manufactured by Dai-ichi Kogyo Seiyaku Co., Ltd.) used as a reactive surfactant was changed to 60 parts. An emulsion-type acryl-based pressure-sensitive adhesive, a pressure-sensitive adhesive layer, and a pressure-sensitive adhesive-type polarizing plate were also prepared as in Example 11, except that the resulting monomer emulsion was used instead.

### Comparative Example 6

A monomer emulsion was prepared as in Example 11, except that the amount of AQUALON HS-10 (manufactured by Dai-ichi Kogyo Seiyaku Co., Ltd.) used as a reactive surfactant was changed to 3 parts. An emulsion-type acryl-based pressure-sensitive adhesive, a pressure-sensitive adhesive layer, and a pressure-sensitive adhesive-type polarizing plate were also prepared as in Example 11, except that the resulting monomer emulsion was used instead.

The pressure-sensitive adhesive-type polarizing plates obtained in the examples and the comparative examples were evaluated as described below. The evaluation results are shown in Table 1.

### Method for Measuring Saturated Water Absorption of Pressure-Sensitive Adhesive Layer>

A 1 mm thick pressure-sensitive adhesive layer was formed by the same method as in each example, except that the thickness of the pressure-sensitive adhesive was changed to 1 mm in each example. The pressure-sensitive adhesive layer was cut into a sample of 5 mm x 5 mm. After water was completely removed from the sample under the condition of 150° C. for 20 minutes, the weight (w1) of the sample was measured. The sample was then allowed to stand in an atmosphere at 50° C. and 90% R.H., while a change in the weight of the sample was observed using an electronic balance sensitive to variations of the order of 0.001 mg. The weight (w2) of the sample was measured at the time when the weight of the sample no longer changed (when the water absorption reached saturation). The following equation was used to calculate the saturated water absorption from the results.

Saturated water absorption=[{(w2)−(w1)}/(w1)]×100 (%)

### [Elongation Percentage]

A cylindrical test piece (pressure-sensitive adhesive layer) with a cross section of 4.6 mm² and a length of 30 mm was made from the same aqueous dispersion-type pressure-sensitive adhesive composition as that used to form the pressure-sensitive adhesive layer in each example. Subsequently, the test piece was allowed to stand in an environment at 60° C. and 7% R.H. or at 60° C. and 90% R.H. for 1 hour and then measured for length L0 (mm). Subsequently, one end of the test piece was fixed, and a 12 g weight was attached to the other end of the test piece. The test piece was suspended in an environment at 60° C. and 7% R.H. or at 60° C. and 90% R.H. for 2 hours and then measured for length L1 (mm).

The elongation percentage (%)={(L1−L0)/L0}×100 was calculated from the results.

The ratio {(L60−90)/(L60)} was calculated, wherein (L60) is the elongation percentage measured using an environment at 60° C. and 7% R.H., and (L60−90) is the elongation percentage measured using an environment at 60° C. and 90% R.H.

### [Heat Durability]

The pressure-sensitive adhesive-type polarizing plate of each of the examples and the comparative examples was cut into a 15 inch size piece, which was bonded to a 0.7 mm thick non-alkali glass plate (Corning Eagle XG, manufactured by Corning Incorporated) and allowed to stand for 15 minutes in an autoclave at 50° C. and 0.5 MPa. The pressure-sensitive adhesive-type polarizing plate was then treated in an atmosphere at 80° C. for 500 hours. The degree of the generation of bubbles in the pressure-sensitive adhesive layer of the treated pressure-sensitive adhesive-type polarizing plate was evaluated with an optical microscope according to the criteria below based on the number and size of the bubbles observed (the bubbles existing before the treatment were omitted when the evaluation was performed).
5: Bubbles with a maximum length of 100 μm or more were not observed per 1 cm².
4:5 or less bubbles with a maximum length of 100 μm or more were observed per 1 cm².
3:6 to 10 bubbles with a maximum length of 100 μm or more were observed per 1 cm².
2:11 to 100 bubbles with a maximum length of 100 μm or more were observed per 1 cm².
1:101 or more bubbles with a maximum length of 100 μm or more were observed per 1 cm².

### [Moisture Durability]

The pressure-sensitive adhesive-type polarizing plate of each of the examples and the comparative examples was cut into a 15 inch size piece, which was bonded to a 0.7 mm thick non-alkali glass plate (Corning Eagle XG, manufactured by Corning Incorporated) and allowed to stand for 15 minutes in an autoclave at 50° C. and 0.5 MPa. The pressure-sensitive adhesive-type polarizing plate was then treated under an environment at 60° C. and 90% R.H. for 500 hours. Within 24 hours after the pressure-sensitive adhesive-type polarizing plate was taken out of the environment and transferred to room temperature conditions (23° C. and 55% R.H.), the degree of peeling between the treated pressure-sensitive adhesive-type polarizing plate and the non-alkali glass was visually observed and evaluated according to the criteria below.
5: No peeling occurred.
4: Peeling occurred from the end of the pressure-sensitive adhesive-type polarizing plate to a site within 0.5 mm from the end.
3: Peeling occurred from the end of the pressure-sensitive adhesive-type polarizing plate to a site within 1.0 mm from the end.
2: Peeling occurred from the end of the pressure-sensitive adhesive-type polarizing plate to a site within 3.0 mm from the end.
1: Peeling occurred from the end of the pressure-sensitive adhesive-type polarizing plate to a site 3.0 mm or more from the end.

TABLE 1

| | | | Surfactant | | | | | | | |
|---|---|---|---|---|---|---|---|---|---|---|
| | | | | Content | | | | | | |
| | | | | (parts) | Pressure-sensitive adhesive layer | | | | | |
| | | | | based on | Saturated | Elongation percentage | | | | |
| | Acryl-based polymer | | | 100 parts | water | | | Ratio: L | Evaluations | |
| | Monomer | Weight ratio | | of the | absorption | L (60): | L (60-90): | (60-90)/ | Heat | Moisture |
| | composition | (%) | Reactivity | monomers | (%) | (%) | (%) | L(60) | durability | durability |
| Example 1 | BA/MMA/AA | 78/20/2 | Reactive | 0.4 | 1.2 | 50 | 120 | 2.40 | 5 | 3 |
| Example 2 | BA/MMA/AA | 78/20/2 | Reactive | 1 | 1.4 | 80 | 220 | 2.75 | 5 | 5 |
| Example 3 | BA/MMA/AA | 78/20/2 | Reactive | 1.9 | 2.3 | 140 | 430 | 3.07 | 4 | 5 |
| Example 4 | BA/MMA/AA | 78/20/2 | Reactive | 3 | 3 | 190 | 630 | 3.32 | 3 | 4 |
| Example 5 | BA/MMA/AA | 88/10/2 | Reactive | 1.9 | 2.5 | 200 | 550 | 2.75 | 4 | 3 |
| Example 6 | BA/MMA/AA | 73/25/2 | Reactive | 1.9 | 2.4 | 130 | 380 | 2.92 | 4 | 5 |
| Example 7 | BA/MMA/AA | 63/35/2 | Reactive | 1.9 | 2.3 | 100 | 320 | 3.20 | 4 | 4 |
| Example 8 | 2EHA/MMA/AA | 78/20/2 | Reactive | 1.9 | 1.6 | 200 | 670 | 3.35 | 4 | 4 |
| Example 9 | BA/MA/AA | 78/20/2 | Reactive | 1.9 | 2.5 | 180 | 560 | 3.11 | 3 | 4 |
| Example 10 | BA/EA/AA | 78/20/2 | Reactive | 1.9 | 2.4 | 200 | 500 | 2.50 | 4 | 4 |
| Example 11 | BA/KBM503/AA | 97.5/0.5/2 | Reactive | 0.5 | 1.5 | 50 | 100 | 2.00 | 5 | 3 |
| Example 12 | BA/KBM503/AA | 97.5/0.5/2 | Reactive | 1.9 | 2.5 | 100 | 220 | 2.20 | 4 | 5 |
| Example 13 | BA/KBM503/AA | 97.5/0.5/2 | Reactive | 3 | 3.2 | 150 | 380 | 2.53 | 3 | 5 |
| Example 14 | BA/KBM503/AA | 97.95/0.05/2 | Reactive | 1.9 | 2.5 | 200 | 500 | 2.50 | 4 | 5 |
| Example 15 | BA/KBM503/AA | 97.9/0.1/2 | Reactive | 1.9 | 2.5 | 150 | 340 | 2.27 | 5 | 4 |
| Example 16 | BA/KBM503/AA | 97.99/0.01/2 | Reactive | 1.9 | 2.5 | 340 | 890 | 2.62 | 3 | 4 |
| Example 17 | BA/KBM503/AA | 97/1/2 | Reactive | 1.9 | 2.4 | 30 | 60 | 2.00 | 5 | 3 |
| Example 18 | BA/MMA/KBM503/AA | 77.95/20/0.05/2 | Reactive | 0.5 | 1.4 | 40 | 100 | 2.50 | 5 | 3 |
| Example 19 | BA/MMA/KBM503/AA | 77.95/20/0.05/2 | Reactive | 1.9 | 2.4 | 120 | 380 | 3.17 | 4 | 5 |
| Example 20 | BA/MMA/KBM503/AA | 77.95/20/0.05/2 | Reactive | 3 | 3 | 160 | 560 | 3.50 | 3 | 4 |
| Example 21 | BA/MMA/KBM503/AA | 87.95/10/0.05/2 | Reactive | 1.9 | 2.5 | 180 | 520 | 2.89 | 3 | 4 |
| Example 22 | BA/MMA/KBM503/AA | 72.95/25/0.05/2 | Reactive | 1.9 | 2.4 | 110 | 350 | 3.18 | 4 | 5 |
| Example 23 | BA/MMA/KBM503/AA | 62.95/35/0.05/2 | Reactive | 1.9 | 2.3 | 90 | 300 | 3.33 | 5 | 4 |
| Example 24 | BA/MMA/KBM503/AA | 77.9/20/0.1/2 | Reactive | 1.9 | 2.5 | 100 | 270 | 2.70 | 5 | 3 |
| Example 25 | BA/MMA/KBM503/AA | 77.99/20/0.01/2 | Reactive | 1.9 | 2.5 | 220 | 670 | 3.05 | 4 | 4 |
| Example 26 | BA/MMA/KBM503/AA | 77.5/20/0.5/2 | Reactive | 1.9 | 2.5 | 60 | 150 | 2.50 | 5 | 4 |
| Example 27 | BA/MMA/KBM503/AA | 77/20/1/2 | Reactive | 1.9 | 2.4 | 20 | 40 | 2.00 | 5 | 3 |
| Comparative | BA/MMA/AA | 78/20/2 | Non-reactive | 2.5 | 4.2 | 360 | 520 | 1.44 | 2 | 2 |
| Example 1 | | | | | | | | | | |
| Comparative | BA/MMA/AA | 78/20/2 | Reactive | 6 | 5.2 | 520 | Broken | Broken | 1 | 3 |
| Example 2 | | | | | | | | | | |
| Comparative | BA/MMA/AA | 78/20/2 | Reactive | 0.2 | 1 | 30 | 50 | 1.67 | 5 | 2 |
| Example 3 | | | | | | | | | | |
| Comparative | BA/MMA/AA | 78/20/2 | Non-reactive | 0.2 | 1.3 | 50 | 80 | 1.60 | 5 | 2 |
| Example 4 | | | | | | | | | | |
| Comparative | BA/KBM503/AA | 97.5/0.5/2 | Reactive | 6 | 6 | 400 | Broken | Broken | 1 | 3 |
| Example 5 | | | | | | | | | | |
| Comparative | BA/KBM503/AA | 97.5/0.5/2 | Reactive | 0.3 | 0.8 | 30 | 40 | 1.33 | 5 | 1 |
| Example 6 | | | | | | | | | | |

In the table, BA represents butyl acrylate, 2EHA 2-ethylhexyl acrylate, MMA methyl methacrylate, MA methyl acrylate, EA ethyl acrylate, AA acrylic acid, and KBM503 3-methacryloyloxypropyl-trimethoxysilane (KBM-503, manufactured by Shin-Etsu Chemical Co., Ltd.).

1. A pressure-sensitive adhesive layer for an optical film, which is formed by a process comprising:
applying an aqueous dispersion-type pressure-sensitive adhesive containing an emulsion of a (meth)acryl-based polymer obtained by subjecting a monomer mixture containing
at least one of an alkyl (meth)acrylate (a1) with an alkyl group of 1 to 3 carbon atoms and an alkoxysilyl group-containing monomer (a2), and
an alkyl (meth)acrylate (b) with an alkyl group of 4 to 14 carbon atoms to emulsion polymerization in water in the presence of a radical polymerization initiator and a reactive surfactant having a radically-polymerizable functional group; and then drying the emulsion,
wherein a content of the reactive surfactant is 0.3 to 3 parts by weight based on 100 parts by weight of the monomer mixture, and
the pressure-sensitive adhesive layer has a saturated water absorption of 1.2 to 3.2% by weight at 50° C. and 90% R.H.

2. The pressure-sensitive adhesive layer for an optical film according to claim 1, wherein the content of the reactive surfactant is 0.3 to less than 2 parts by weight based on 100 parts by weight of the monomer mixture.

3. The pressure-sensitive adhesive layer for an optical film according to claim 1, wherein the monomer mixture contains 0.1 to 40% by weight of the alkyl (meth)acrylate (a1) with an alkyl group of 1 to 3 carbon atoms and 50 to 99.9% by weight of the alkyl (meth)acrylate (b) with an alkyl group of 4 to 14 carbon atoms based on the total amount of the monomer mixture.

4. The pressure-sensitive adhesive layer for an optical film according to claim 1, wherein the monomer mixture contains 0.001 to 1% by weight of the alkoxysilyl group-containing monomer (a2) and 89 to 99.999% by weight of the alkyl (meth)acrylate (b) with an alkyl group of 4 to 14 carbon atoms based on the total amount of the monomer mixture.

5. The pressure-sensitive adhesive layer for an optical film according to claim 1, wherein the monomer mixture contains 0.1 to 40% by weight of the alkyl (meth)acrylate (a1) with an alkyl group of 1 to 3 carbon atoms, 0.001 to 1% by weight of the alkoxysilyl group-containing monomer (a2), and 89 to 99.999% by weight of the alkyl (meth)acrylate (b) with an alkyl group of 4 to 14 carbon atoms based on the total amount of the monomer mixture.

6. The pressure-sensitive adhesive layer for an optical film according to claim 1, wherein the monomer mixture contains 0.1 to 10% by weight of a carboxyl group-containing monomer (c) based on the total amount of the monomer mixture.

7. The pressure-sensitive adhesive layer for an optical film according to claim 1, which has an elongation percentage (L60) of 200% or less in an environment at 60° C. and 7% R.H. and a ratio {(L60−90)/(L60)} of at least 1.5, wherein {(L60−90)/(L60)} is the ratio of an elongation percentage (L60−90) in an environment at 60° C. and 90% R.H. to the elongation percentage (L60) in an environment at 60° C. and 7% R.H., and the elongation percentage is determined from the following equation: elongation percentage (%)={(L1−L0)/L0}×100 by a process comprising forming the pressure-sensitive adhesive layer into a cylindrical test piece with a cross section of 4.6 mm² and a length of 30 mm, allowing the test piece to stand in an environment at 60° C. and 7% R.H. or at 60° C. and 90% R.H. for 1 hour, then measuring the length L0 (mm) of the test piece, then suspending the test piece in an environment at 60° C. and 7% R.H. or at 60° C. and 90% R.H. for 2 hours, while fixing one end of the test piece and attaching a 12 g weight to the other end of the test piece, and then measuring the length L1 (mm) of the test piece.

8. A pressure-sensitive adhesive optical film, comprising an optical film and the pressure-sensitive adhesive layer for an optical film according to claim 1 placed on at least one side of the optical film.

9. The pressure-sensitive adhesive optical film according to claim 8, wherein the optical film, on which the pressure-sensitive adhesive layer is placed, has a moisture permeability of 1,000 g/m² per 24 hours at 80° C. and 90% R.H. or less.

10. The pressure-sensitive adhesive optical film according to claim 8, wherein the optical film is a polarizing plate comprising a polarizer and a transparent protective film provided on at least one side of the polarizer.

11. An image display comprising at least one piece of the pressure-sensitive adhesive optical film according to claim 8.
